(19) United States
(12) Patent Application Publication
(10) Pub. No.: US 2008/0139775 A1
(43) Pub. Date: Jun. 12, 2008

(54) Abrasion resistant two-component waterborne polyurethane coatings

(76) Inventors: Xiaodong Wu, Newtown, PA (US); Richard Rosen, Princeton, NJ (US)

Correspondence Address: Kevin E. McVeigh;RHODIA INC., 8 Cedar Brook Drive (CN 7500), Cranbury, NJ, 08512-7500, US

(21) Appl. No.: 11/999,590

(22) Filed: Dec. 6, 2007

Related U.S. Application Data
(60) Provisional application No. 60/873,178, filed on Dec. 6, 2006.

(51) Int. Cl. C08G 18/00; B05D 3/00

(52) U.S. Cl. 528/44; 427/385.5

(57) ABSTRACT

A reactive coating composition, contains (a) a water dispersible isocyanate component, comprising (a)(1) one or more hydrophobic polyisocyanate oligomers, (a)(2) one or more surface active agents, and (b) a water dispersible polyol component comprising: (b)(1) one or more acrylic polyols, and (b)(2) one or more polyester polyols and provides cured films having improved abrasion resistance.

### FIELD OF THE INVENTION

The invention relates generally to two-component waterborne polyurethane coatings and more particularly to abrasion resistant two-component waterborne polyurethane coatings.

### BACKGROUND OF THE INVENTION

In two-component waterborne polyurethane coatings, a water dispersible polyisocyanate, also referred to as water-emulsifiable, waterborne, or hydrophilic polyisocyanate, is added to an aqueous polymer dispersion. The aqueous polymer dispersion is usually a polyol or acrylic polyol/polyester polyol blend. These two-component waterborne polyurethane coating compositions are currently of great importance in the polyurethane coatings industry due to their excellent film properties and their durability. More significantly, they are eco-friendly with a low or negligible volatile organic content (VOC). The description of typical hydrophilic polyisocyanate compositions, their use in two-component waterborne polyurethane coating compositions, and the process which facilitates easy dispersion of hydrophilic polyisocyanates in water with a greatly reduced requirement of added volatile organic solvents is contained in U.S. patent application Ser. No. 11/006,943. Notwithstanding the environmental benefits, providing a stronger or abrasion resistant two-component water-based polyurethane coatings has been difficult.

It is known that two-component coating compositions containing a hydrophilically modified aliphatic polyisocyanate can easily self-emulsify into water and an isocyanate-reactive component, such as water dispersible polyols. Emulsifying surfactant packages significantly improve the mixing and application of the polyisocyanates into such water-based coating compositions. Therefore, the hydrophilic polyisocyanates can be formulated with water dispersible acrylic polyols, polyester polyols, or PUDs in conventional two-component water-based polyurethane coatings.

It is also known that a two-component polyurethane coating composition maybe formed from a polyisocyanate component and an acrylic polyol component. For example, U.S. Pat. No. 7,005,470 to Probst et al discloses a two-component water-based polyurethane system comprising an acrylic polyol component and a polyisocyanate component. The acrylic polyol may be partly neutralized after the end of polymerization with a hydroxyl-functional polyether. However, although the use of an acrylic polyol alone in a two-component water-based composition may provide the desired hardness and crosslinking, the compositions have poor abrasion resistant characteristics. It has been observed that the use of polyester polyol in the absence of an acrylic polyol component provides coatings with excellent abrasion resistance, but poor hardness characteristics and poor dry times.

It is therefore an object of this invention to provide a two-component water-based polyurethane coating composition having improved abrasion resistance, rapid development of hardness, crosslinking and dry time characteristics.

### SUMMARY OF THE INVENTION

The invention is directed to a reactive coating composition, comprising:
(a) a water dispersible isocyanate component, comprising

(a)(1) one or more hydrophobic polyisocyanate oligomers,

(a)(2) one or more surface active agents, and
(b) a water dispersible polyol component comprising:

(b)(1) an acrylic polyol, and

(b)(2) a polyester polyol.

Films made by curing the composition of the present invention provide improved abrasion resistance, rapid development of hardness, crosslinking and dry time characteristics.

### BRIEF DESCRIPTION OF THE DRAWINGS

FIG. 1 shows results of dynamic mechanical analysis of embodiments of films made from reactive coating compositions according to the present invention.

FIG. 2 shows results of dynamic mechanical analysis of embodiments of films made from reactive coating compositions according to the present invention.

### DETAILED DESCRIPTION OF INVENTION AND PREFERRED EMBODIMENTS

As used herein, the term “two-component” refers to the minimum number of solutions and/or dispersions, which are mixed together to provide a curable coating composition. Once mixed, the resulting curable coating composition may be applied to a surface.

Generally a formulation for a two-component water-based polyurethane coating will comprise a polyisocyanate part and an aqueous polymer dispersion which may be a polyol or a blend of polyols. As discussed above, two-component coating compositions typically contain a water dispersible polyisocyanate that can easily self-emulsify into water and an isocyanate-reactive component, such as a water dispersible polyol.

We have discovered that a two-component water-based polyurethane coating comprising a hydrophilic isocyanate component and an aqueous polymer blend of acrylic polyol and polyester polyol has excellent coating characteristics, such as gloss, hardness, pot-life, dry time, chemical resistance, durability, and abrasion resistance. It has been observed that using acrylic polyol, in the absence of polyester polyol, in a two-component water-based coating formulation produces coatings with good hardness and crosslinking, but poor abrasion resistance. It has also been observed that using polyester polyol, in the absence of acrylic polyol in a two-component water-based coating formulation produces a coating with improved abrasion resistance, but low hardness and very slow dry time.

In one embodiment, the coating composition of the present invention has a low volatile organic content, typically less than or equal to about 350 grams per liter (“g/L”), more typically less than or equal to about 200 g/L, and in some embodiments, less than 100 g/L.

In one embodiment, the film according to the present invention exhibits high resistance to abrasion, as indicated by a weight loss of less than or equal to about 40 milligrams, more typically less than or equal to about 35 milligrams, from a uniform coating of between 2 to 3 mils thickness after seven-day cure measured according to ASTM D 4060-95 under test conditions 1000 cycles and 1 Kilogram weight using CS-17 wheels.

By using a blend system of an acrylic polyol and a polyester polyol, the abrasion resistance of the coating can be improved. The improvement is attributed to the interpenetrating network structure during the film formation and a toughening mechanism.

In accordance with the invention a first component of a two-component polyurethane coating composition generally comprises a) hydrophilic polyisocyanate. A second component is generally an aqueous polymer dispersion, which is typically an acrylic polyol/polyester polyol blend. The present invention also relates to a process for the preparation of hydrophilic polyisocyanate base compositions.

### Part (a)—Water Dispersible Polyisocyanate Component

(a)(1)—Hydrophobic Polyisocyanate

Any suitable hydrophobic polyisocyanate may be used in accordance with the invention. Hydrophobic polyisocyanates are generally aliphatic, cylcoaliphatic or aromatic diisocyanates or polyisocyanates that have NCO functionality higher than 2, more typically between 2.5 and 10, and even more typically between 2.8 and 6.0, and are in some cases mixed with surfactants or reacted with compounds having at least one hydrophilic group and having at least one group reactive toward isocyanate. As used herein in reference to a polyisocyanate oligomer, the terminology “NCO functionality” means the number of isocyanate (“NCO”) groups per molecule of polyisocyanate oligomer. Any suitable polyisocyanate may be used to produce a hydrophobic polyisocyanate in accordance with the invention. Suitable isocyanates useful in accordance with the invention are set forth in more detail below.

These compounds may typically contain structures that are common in this field, for example, pre-polymers originating from the condensation of polyol (For example trimethylopropane) in general triol (typically primary alcohol, see below on the definition of the polyols) and above all the most common ones, namely those of isocyanurate type, also called trimer, uretdione structures, also called dimer, biuret or allophanate structures or a combination of this type of structures on one molecule alone or as mixture.

If it is desired to greatly lower the solvent content of the composition, especially when it is in the form of emulsion, it is preferable to employ mixtures of this type naturally (that is to say without addition of solvent) with low viscosity. The compounds exhibiting this property are above all the derivatives (isocyanurate type, also called trimer, uretdione structures, also called dimer, biuret or allophanate structures or a combination of this type of structures on one molecule alone or as mixture) partially and/or totally of the aliphatic isocyanates in which the isocyanate functional groups are joined to the backbone through the intermediacy of ethylene fragments (For example polymethylene diisocyanates, especially hexamethylene diisocyanate) or a cycloaliphatic moiety (For example in isophorone diisocyanate) and of the arylenedialkylene diisocyanates in which the isocyanate functional group is at a distance of at least two carbons from the aromatic nuclei, such as (OCN-[CH₂]ₜ-Φ-[CH₂]ᵤ-NCO) with t and u greater than 1. These compounds or mixtures typically have a viscosity at most equal to about 20000 centipoises (or millipascal second), typically to about 2000 centipoises (or millipascal second).

In one embodiment, the hydrophobic polyisocyanate oligomer comprises a product of a condensation reaction of isocyanate monomers. Suitable isocyanate monomers include, for example, aliphatic and cycloaliphatic diisocyanate monomers, such as 1,6-hexamethylene diisocyanate bis(isocyanato-methylcyclohexane) and the cyclobutane-1,3-diisocyante, cyclohexane-1,3-diisocyanate, cyclohexane-1,4-diisocyanate; Norborne diisocyanate, isophorone diisocyanate, 3-isocyanatomethyl-3,5,5-trimethylcyclo-hexylisocyanate, and aromatic diisocyanate monomers, include, for example, 2,4- or 2,6-toluene diisocyanate; 2,6-4,4′-diphenylmethane diisocyanate; 1,5-naphthalene diisocyanate and p-phenyl diisocyanate. In one embodiment, the isocyanate monomer comprises 1,6-hexamethylene diisocyanate.

In one embodiment, the hydrophobic polyisocyanate oligomer is made by condensation of isocyanate monomers to form a mixture of oligomeric species, wherein such oligomeric species each comprise two or more monomeric repeating units per molecule, such as, for example, dimeric species, consisting of two monomeric repeating units per molecule (“dimers”), and trimeric species consisting of three monomeric repeating units per molecule (“trimers”), and wherein such monomeric repeating units are derived from such monomers. In one embodiment, the polyisocyanate oligomer further comprises polyisocyanate oligomeric species comprising greater than three monomeric repeating units per molecule, such as, for example, the respective products of condensation of two dimers (“bis-dimers”) of two trimers (“bis-trimers”), or of a dimer with a trimer as well as higher order analogs of such polycondensation products.

In one embodiment, the hydrophobic polyisocyanate oligomer comprises one or more oligomeric species comprising two or more monomeric units per molecule, typically including: (i) compounds with at least one isocyanurate moiety, (ii) compounds with at least one uretidinedione moiety and (iii) compounds with at least one isocyanurate moiety and at least one uretidinedione moiety.

(a)(2) Surface Active Agent

The terminology “surface active agent” is used herein according to its conventional meaning, that is, any compound that reduces surface tension when dissolved in water or in an aqueous solution.

In one embodiment, the surface active agent comprises a polyisocyanate surface active agent. Suitable polyisocyanate surface active agents include, for example, those made by grafting ionic substituents, polyalkylene oxide chains, or ionic substituents and polyalkylene oxide chains onto a polyisocyanate molecule. Certain suitable surfactant-based polyisocyanates for use in accordance with the invention are described in U.S. patent application Ser. No. 11/006,943 which is herein incorporated by reference. These polyisocyanates include compositions based on isocyanate(s), typically not masked, where the composition comprises at least one compound containing an anionic functional group and typically a polyethylene glycol chain fragment of at least 1, more typically of at least 5 ethyleneoxy units,

In one embodiment, the surface active agent comprises one or more surfactant compounds selected from anionic surfactants, such as sulfate or sulfonate surfactants, cationic surfactants, such as quaternary ammonium surfactants amphoteric/zwitterionic surfactants, such as betaine surfactants, nonionic surfactants, such as an alkoxylated alcohol, and mixtures thereof. These surface-active agents may also be chosen from ionic compounds [especially aryl and/or alkyl sulphate or phosphate (of course aryl includes especially alkylaryls and alkyl includes especially aralkyls), aryl- or alkyl phosphonate, -phosphinate, sulphonate, fatty acid salt and/or zwitterionic] and among the nonionic compounds those blocked at the end of a chain or not. (However, it should be noted that nonionic compounds which have alcoholic functional groups on at least one of the chains seem to have a slightly unfavorable effect on (auto)emulsion even though they have a favorable effect on other aspects of the composition, for example, painting; bearing this in mind, it is preferable that the content of this type of compound represent at most one third, typically at most one fifth, typically at most one tenth of the mass of the said anionic compounds according to the invention.)

In one embodiment, the surfactant compound contains a hydrophilic part formed of said anionic functional group, of said (optional) polyethylene glycol chain fragment and of a lipophilic part based on a hydrocarbon radical.

The lipophilic part of the surfactant compound is generally chosen from alkyl groups and aryl groups. When the number of ethylene glycol functional group is at most equal to 5, the simple alkyls are typically branched, typically from C₈ to C₁₂, the aralkyls C₁₂ to C₁₆, the alkylaryls from C₁₀ to C₁₄ and the simple aryls are C₁₀ to C₁₆. Otherwise the lipophilic part can vary widely above all when the number of ethylene glycol units is above 10, it may thus constitute a hydrocarbon radical of at least 1, typically of at least 3 and containing at most 25 typically at most 20 carbon atoms.

In one embodiment, the surfactant compound comprises one or more compounds according to formula (I).

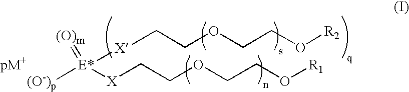

wherein:

q is 0 or 1;

p is 1 or 2;

m is 0, 1 or 2;

X and X′ are each independently divalent aliphatic linking groups. typically, methylene or dimethylene;

s is 0 or an integer from 1 to 30, typically from 5 to 25, more typically from 9 to 20;

n is 0 or an integer from 1 to 30, typically from 5 to 25, more typically from 9 to 20;

E is an atom chosen from carbon and the metalloid elements of atom row at least equal to that of phosphorus and belonging to column VB or to the chalcogens of atom row at least equal to that of sulphur; and

R₁ and R₂ are each independently hydrocarbon radicals, typically chosen from optionally substituted aryls, alkyl, and alkenyl moieties, more typically, (C₁-C₆)alkyl, and

M⁺ is a counterion.

Although this does not form part of the preferred compounds, it is appropriate to note that s and/or n can be equal to zero, with the condition that E is phosphorus and that when s and n are equal to zero, R₁ and/or R₂ are respectively alkyls from C₈ to C₁₂, typically branched, or an aralkyl from C₁₂ to C₁₆ or an alkylaryl from C₁₀ to C₁₄.

One of the divalent radicals X and X′ can also be a radical of type ([EOₘ(O⁻)ₚ]) so as to form pyroacids like the symmetric or otherwise diesters of pyrophosphoric acid.

The total carbon number of the anionic compounds aimed at by the present invention is typically at most about 100, typically at most about 50.

The divalent radicals X and optionally X′ are typically chosen from the divalent radicals consisting of (the left-hand part of the formula being bonded to the first E):

when E is P, one of the X or X′ may be O-P(O)(O⁻)-X″-;

when E is P, one of the X or X′ may be -O-(R₁₀-O)P(O)-X″-; (R₁₀ being defined below) (X″ denoting an oxygen or a single bond);

a direct bond between E and the first ethylene of the said polyethylene glycol chain fragment;

methylenes which are optionally substituted and in this case typically partly functionalized;

the arms of structure -Y- and of structure -D-Y-, -Y-D- or -Y-D-Y′,

where Y denotes a chalcogen (typically chosen from the lightest ones, namely sulfur and above all oxygen), metalloid elements of the atom rows at most equal to that of phosphorus and belonging to column VB in the form of derivatives of amines or of tertiary phosphines (the radical providing the tertiary character being typically of at most 4 carbons, typically of at most 2 carbons);

where D denotes an alkylene, which is optionally substituted, including functionalized, D being typically ethylene or methylene, typically ethylene in the structures -D-Y- and above all -Y-D-Y′, and methylene in the structures -Y-D-,

thus, E denotes an atom chosen from carbon atoms (typically in this case m=1 and p=1, the prototype of this type of compound is an alcohol acid [For example, lactic or glycolic acid], which is polyethoxylated) the atoms giving salts containing an element of group VB (elements As or Sb) (elements of column VB) (typically in this case m=1 or 0 and p=1 or 2), chalcogen atoms of row higher than oxygen (typically in this case m=1 or 2 and p=1 and q=0).

In one embodiment, E is a phosphorus atom and R₁ and R₂ are each independently (C₁-C₆)alkyl.

Thus, in the case where E is chalcogen the formula I is typically simplified to formula (II):

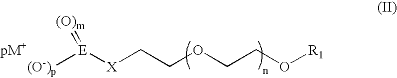

wherein E, m, n, X, p, R₁ and M⁺ are each as described above.

E typically denotes carbon, phosphorus or sulfur, most typically phosphorus. In the case wherein E=P and q=0, the formula (I) simplifies to formula (Il-a):

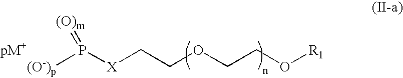

wherein p, m, n, X, R₁, and M⁺ are each as described above.

The optional functionalization of the alkylenes and especially methylenes (X and X′) is done by hydrophilic functional groups (tertiary amines and other anionic functional groups including those which are described above [EOₘ(O⁻)ₚ]).

The counter-cation M⁺ is typically monovalent and is chosen from inorganic cations and organic cations, typically non-nucleophilic and consequently of quaternary or tertiary nature (especially oniums of column V, such as phosphonium, ammoniums, or even of column VI, such as sulphonium, etc.) and mixtures thereof, in most cases ammoniums, in general originating from an amine, typically tertiary. The presence on the organic cation of a hydrogen that is reactive with the isocyanate functional group is typically avoided, hence, the preference for tertiary amines.

The inorganic cations may be sequestered by phase transfer agents like crown ethers.

The pKa of the cations (organic or inorganic) is typically between 8 and 12.

The cations and especially the amines corresponding to the ammoniums typically do not exhibit any surface-active property but it is desirable that they should exhibit a good solubility, sufficient in any event to ensure it is in the compounds containing an anionic functional group and typically a polyethylene glycol chain fragment, in aqueous phase, this being at the concentration for use. Tertiary amines containing at most 12 atoms, typically at most 10 atoms, typically at most 8 atoms of carbon per “onium” functional group are preferred (it must be remembered that it is preferred that there should be only one thereof per molecule). The amines may contain another functional group and especially the functional groups corresponding to the amino acid functional groups and cyclic ether functional groups like N-methylmorpholine, or not. These other functional groups are typically in a form that does not react with isocyanate functional groups and do not significantly alter the solubility in aqueous phase.

It is highly desirable that the anionic compounds according to the present invention should be in a neutralized form such that the pH which it induces when being dissolved in, or brought into contact with water, is at greater than or equal to 3, more typically greater than or equal to 4, and even more typically greater than or equal to 5, and less than or equal to 12, more typically less than or equal to 11, and even more typically less than or equal to 10.

When E is phosphorus it is desirable to employ mixtures of monoester and of diester in a molar ratio of between about 1/10 and about 10, typically between about 1/4 and about 4. Such mixtures may additionally contain from 1% up to about 20% (it is nevertheless preferable that this should not exceed about 10%) by mass of phosphoric acid (which would be typically at least partially converted into salt form so as to be within the recommended pH ranges), and from 0 to about 5% of pyrophosphoric acid esters.

The mass ratio between the surface-active compounds (including the said compound containing an anionic functional group and typically a polyethylene glycol chain fragment) and the polyisocyanates is very typically between 4 and about 20%, typically between about 5% and about 15% and even more typically between about 6% and about 13%.

After being converted into dispersion or emulsion in an aqueous phase, a water dispersible polyisocyanate composition according to the invention may have a water content of about 10 to about 70%. The emulsion is an oil-in-water emulsion.

Alternatively, for the preparation of a grafted surface active or hydrophilic polyisocyanate, the isocyanates described above, alone or in combination, may be mixed with compounds which have at least one, typically one, hydrophilic group and at least one, typically one, group reactive with isocyanate, for example hydroxyl, mercapto or primary or secondary amino (NH group for short) as described in U.S. Pat. No. 5,587,421.

The hydrophilic group may be, for example, a nonionic group, an ionic group or a group convertible into an ionic group.

Anionic groups or groups convertible into anionic groups are, for example, carboxyl and sulfo groups.

Examples of suitable compounds are hydroxycarboxylic acids, such as hydroxypivalic acid or dimethylol propionic acid, and hydroxy and aminosulfonic acids.

Cationic groups or groups convertible into cationic groups are, for example, quaternary ammonium groups and tertiary amino groups.

Groups convertible into ionic groups are typically converted into ionic groups before or during dispersing of the preferred compositions in water.

In order to convert, for example, carboxyl or sulfo groups into anionic groups, inorganic and/or organic bases, such as sodium hydroxide, potassium hydroxide, potassium carbonate, sodium bicarbonate, ammonia or primary, secondary or in particular tertiary amines, e.g. triethylamine or dimethylaminopropanol, may be used.

For converting tertiary amino groups into the corresponding cations, for example ammonium groups, suitable neutralizing agents are inorganic or organic acids, for example hydrochloric acid, acetic acid, fumaric acid, maleic acid, lactic acid, tartaric acid, oxalic acid or phosphoric acid and suitable quaternizing agents are, for example, methyl chloride, methyl iodide, dimethyl sulfate, benzyl chloride, ethyl chloroacetate or bromoacetamide. Any suitable neutralizing and quaternizing agents may be used.

The content of ionic groups or of groups convertible into ionic groups is typically from 0.1 to 3 mol/kg of the surface active polyisocyanates.

Nonionic groups are, for example, polyalkylene ether groups, in particular those having from 5 to 80 alkylene oxide units. Polyethylene ether groups or polyalkylene ether groups, which contain from 5 to 20, even more typically from 5 to 15 ethylene oxide units in addition to other alkylene oxide units, e.g. propylene oxide, are preferred.

Examples of suitable compounds include polyalkylene ether alcohols.

The content of hydrophilic nonionic groups, in particular of polyalkylene ether groups, is typically from 0.5 to 20%, particularly typically from 1 to 15% by weight, based on the surface active polyisocyanates.

The preparation of the surface active polyisocyanates is well known in the art and is disclosed in DE-A-35 21 618, DE-A40 01 783 and DE-A42 03 510.

In the preparation of the surface active polyisocyanates, the compounds containing at least one hydrophilic group and at least one group reactive toward isocyanate may be reacted with some of the isocyanate, and the resulting hydrophilized polyisocyanates can then be mixed with the remaining polyisocyanates. However, the preparation may also be carried out by adding the compounds to the total amount of the polyisocyanates and then effecting the reaction in situ.

Preferred surface active polyisocyanates are those containing hydrophilic, nonionic groups, in particular polyalkylene ether groups. The water emulsifiability is typically achieved exclusively by the hydrophilic nonionic groups.

In one embodiment, the surface active isocyanate compound comprises one or more polyalkylene ether-grafted isocyanate compounds according to formula (III):

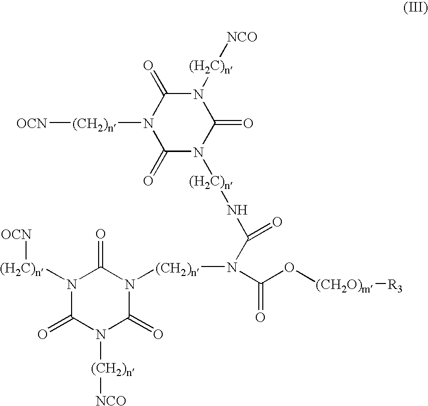

wherein:

each n′ is independently an integer of from 1 to about 20, and

m′ is an integer of from 2 to about 30, and

R₃ is an aliphatic or aromatic hydrocarbon radical, typically (C₁-C₆) alkyl.

In another embodiment, the surface active polyisocyanate comprises an anionic-functionalized isocyanate compound, such as, for example, 3-(cyclohexylamino)-1-propan-sulfonic acid and salts thereof.

The hydrophilic polyisocyanate component typically comprises up to about 40% by weight solvent, even more typically between 1 and 20% by weight solvent; and most typically between about 5 to 15% by weight solvent.

In a two-component polyurethane coating composition, the hydrophilic polyisocyanate composition is used as an additive, for example, a crosslinking agent or hardener, for aqueous polymer dispersions or emulsions. To produce films, two-components are mixed, I) the hydrophilic polyisocyanate, which may or may not be blocked, and II) a dispersion of aqueous polymers. In accordance with the invention, the aqueous polymer dispersion is a blend of acrylic polyol and polyester polyol. The polyol blend may be obtained by radical polymerization or by polycondensation polymerization (for example polyesters).

Simple mixing by using mechanical devices or simple hand mixing of the hydrophilic polyisocyanate compositions of the invention allows them to be finely dispersed into aqueous emulsions or dispersions. The emulsions obtained in accordance with the invention exhibit improved pot-life.

The mixture of the dispersions, which may also contain pigments and fillers, is then deposited on a substrate in the form of a film with the aid of conventional techniques for applying industrial coatings. When the preparation contains blocked isocyanates the combination of film plus substrate is cured at a sufficient temperature to ensure the de-blocking of the isocyanate functional groups and the condensation of the latter with the hydroxyl groups of the aqueous polymer dispersion particles.

In the present description the particle size characteristics frequently refer to notations of the dₙ type, where n is a number from 1 to 99; this notation is well known in many technical fields but is a little rarer in chemistry, and therefore it may be useful to give a reminder of its meaning. This notation represents the particle size such that n % (by weight, or more precisely on a mass basis, since weight is not a quantity of matter but a force) of the particles are smaller than or equal to the said size.

In accordance with the invention the mean sizes (d₅₀) of the hydrophilic polyisocyanate emulsion and the aqueous polymer dispersion is less than 1000 nm, typically less than 500 nm and is most typically between about 50 nm and 200 nm. Preferred aqueous polymer dispersions employed in combination with these emulsions have mean sizes measured by quasi-elastic scattering of light which are between 20 nm and 200 nm and more generally between 50 nm and 150 nm.

When dispersions of different sizes are mixed at high a concentration, which is generally the case, instability is observed in the mixtures of the two dispersions. To give an example, this instability is reflected in a fast macroscopic separation, generally over a few minutes, to give, on the one hand, a fluid phase and, on the other hand, a very viscous phase. This results not only in it being impossible to preserve (store) these mixtures, but also in extreme difficulty in applying this mixture to the surface that it is desired to cover according to the usual techniques for the application of paints and varnishes. If these unstable mixtures are applied onto a substrate, such as onto a sheet of glass or metal, the resulting film is not transparent but looks opaque and heterogeneous and is therefore not suitable.

An objective of the present invention is to provide compositions comprising a hydrophilic isocyanate emulsion and an aqueous acrylic polyol/polyester polyol blend which are physically stable for at least 2 to 24 hrs, typically 4 to 24, most typically 6 to 24 hrs. The other objective of the invention is to obtain, from these stable and fluid mixtures, films exhibiting abrasion resistance, good gloss, transparency and solvent resistance and chemical resistance properties.

These objectives are attained by means of a composition comprising: at least a hydrophilic polyisocyanate in solvent which gives an aqueous emulsion whose mean particle size d₅₀ is less than 1000 nm, typically less than 500 nm and even more typically between 50 nm to 200 nm; and at least one aqueous acrylic polyol/polyester polyol blend whose mean particle size is between 20 nm and 200 nm and more generally between 50 nm and 200 nm.

The ratio of the number of hydroxyl functional groups to the number of isocyanate functional groups, masked or otherwise, can vary very widely, as shown above. Ratios that are lower than the stoichiometry promote plasticity, while ratios that are higher than the stoichiometry produce coatings of great hardness. These ratios are typically in a range extending from 0.5 to 3.0, typically between 0.8 and 1.6, and even more typically between 1.0 and 1.4.

As a general guiding principle, approximately 10% by weight of the isocyanate may be added to the coating composition as hardener. The hydrophilic polyisocyanate component may be typically added to the aqueous polyol blend in amounts from 0.5% to 30%, and more typically from 1% to 15% by weight, based on the polyol blend.

### Part (b) Polyol Component

The aqueous polymer blend of the invention comprises an acrylic polyol and a polyester polyol. Any suitable water dispersible or water reducible acrylic polyol and polyester polyol may be used.

In one embodiment, the polyol component (b) of the reactive coating composition of the present invention comprises, based on 100 parts by weight (“pbw”) of the total amount of polyols (solids basis) in the composition:
(b)(1) from about 50 to about 98 pbw, more typically from about 50 to about 95 pbw, and even more typically from about 50 to about 90 pbw of the acrylic polyol, and
(b)(2) from about 2 to about 50 pbw, more typically from about 5 to about 50 pbw, and even more typically from about 10 to about 50 pbw of the polyester polyol.

In one embodiment of the invention, the polyol is a polymer that contains at least 2 hydroxyl groups (phenol or alcohol) that typically have a proportion of hydroxyl of between 0.5 and 5, typically between 1 and 3 % (by mass). Except in the case of the lattices, which will be recalled later, it typically contains between 2 to 20% by mass primary and secondary alcohol functional groups. However, it may additionally contain secondary or tertiary alcoholic functional groups (in general at most approximately 10, typically at most 5, more frequently at most two) which, in general, do not react or react only after the primary ones, this being in the order primary, secondary, and tertiary.

The polyol may contain anionic groups, especially carboxylic or sulphonic, or may not contain any ionic group.

The polyol can already be in an aqueous or water-soluble or water-dispersible medium.

It may be an aqueous solution (which may in particular be obtained after neutralization of the ionic groups) or an emulsion of the polymer in water or a dispersion of latex type.

In particular it is typically possible to employ lattices, especially nano-lattices (that is to say lattices in which the particle size is nanometric [more precisely, in which the d₅₀ is at most equal to approximately 100 nm]).

Thus, according to one of the particularly preferable applications of the present invention, the polyol is typically a latex of nanometric size exhibiting the following characteristics:

d₅₀ of between 15 nm and 60 nm, typically between 20 nm and 40 nm,

carboxylate functional group from 0.5 to 5% by mass,

hydroxyl functional group: between 1 and 4% typically between 2 and 3%,

solid content: between 25 and 40%, and a d₈₀ smaller than 1 micrometer.

In addition, the lattices, above all when their glass transition point is lower than 0° C., typically than −10° C., typically than −20° C., make it possible to obtain even with aromatic isocyanates good quality of resistance to inclement weather and especially to temperature variations.

In one embodiment, the acrylic polyol has a glass transition temperature of from 15 to 100° C., typically from 20° C. to 80° C.

In one embodiment, the polyester polyol has a glass transition temperature of from −100° C. to less than 15° C., typically from −50° C. to less than 10° C.

In one embodiment, the molar ratio between the free isocyanate functional groups and the hydroxyl functional groups is between 0.5 and 3.0, typically between 0.8 and 1.6, and even more typically between 1 and 1.4.

The lattices (which are not functionalized in respect of isocyanate which are optionally masked) that are described in the French Patent Application filed on Apr. 28, 1995 No. 95/05123 and in the European Patent Reflex Application No. EP 0,739,961 give very good results.

Thus, the latex particles typically exhibit an acidic (typically carboxylic) functional group content that is accessible of between 0.2 and 1.2 milliequivalents/gram of solid content and they exhibit an accessible alcoholic functional group content of between 0.3 and 1.5 milliequivalents/gram.

In one embodiment, the lattices consisting of particles carrying functional group(s) according to the invention are hydrophobic and typically have a size (d₅₀) that is generally between 50 nm and 150 nm. They are calibrated, mono-disperse, and present in the latex in a proportion of a quantity varying between 0.2 to 65% by weight of the total weight of the latex composition.

In one embodiment, the aqueous polymer dispersions containing reactive hydrogen groups are the known polyester polyols and polyacrylates. In a one embodiment of the invention, the acrylic polyol component of the film forming aqueous acrylic polyol/polyester polyol blend reactable with the hydrophilic isocyanate is an acrylic resin, which may be a polymer or oligomer. The acrylic polymer or oligomer typically has a number average molecular weight of 500 to 1,000,000, and more typically of 1000 to 30,000. Acrylic polymers and oligomers are well-known in the art, and can be prepared from monomers such as methyl acrylate, acrylic acid, methacrylic acid, methyl methacrylate, butyl methacrylate, cyclohexyl methacrylate, and the like. The active hydrogen functional group, e.g., hydroxyl, can be incorporated into the ester portion of the acrylic monomer. For example, hydroxy-functional acrylic monomers that can be used to form such resins include hydroxyethyl acrylate, hydroxybutyl acrylate, hydroxybutyl methacrylate, hydroxypropyl acrylate, and the like. Amino-functional acrylic monomers would include t-butylaminoethyl methacrylate and t-butylamino-ethylacrylate. Other acrylic monomers having active hydrogen functional groups in the ester portion of the monomer, such as vinyl esters or vinyl acetate, are also within the skill of the art. Other monomer units may be substituted styrene derivatives, such as, for example, vinyltoluenes, α-methylstyrene, propenylbenzene, isobornyl acrylate.

Modified acrylics can also be used. Such acrylics may be polyester-modified acrylics or polyurethane-modified acrylics, as is well-known in the art. Polyester-modified acrylics modified with e-caprolactone are described in U.S. Pat. No. 4,546,046 of Etzell et al, the disclosure of which is incorporated herein by reference. Polyurethane-modified acrylics are also well-known in the art. They are described, for example, in U.S. Pat. No. 4,584,354, the disclosure of which is also incorporated herein by reference.

Polyesters having active hydrogen groups such as hydroxyl groups are also suitable as a component of the aqueous polymer blend according to the invention. Such polyesters are well-known in the art, and may be prepared by the polyesterification of organic polycarboxylic acids (e.g., phthalic acid, hexahydrophthalic acid, adipic acid, maleic acid) or their anhydrides with organic polyols containing primary or secondary hydroxyl groups (e.g., ethylene glycol, butylene glycol, neopentyl glycol).

The preparation of the polyol components typically takes place directly in aqueous phase by emulsion polymerization. In accordance with the invention, an acrylic polyol and polyester polyol may be synthesized with the phosphated monomers of the invention, to form the aqueous polymer blend component of a two-component system. Typically, the acrylic polyol is synthesized with from about 0.5% to about 10% by weight (“% by wt.”) phosphated monomers. Most typically the acrylic polyol is synthesized with about 4% by wt. phosphated monomers. However any suitable synthesis process may be employed.

In a two-component system the acrylic polyol/polyester polyol blend may function as a film forming polymer. However, the film forming component of a two-component system in accordance with the invention may also comprises additional film forming polymers. The film forming polymer will generally comprise at least one functional groups selected from the group consisting of active hydrogen containing groups, epoxide groups, and mixtures thereof. The functional group is typically reactive with one or more functional groups of the hydrophilic polyisocyanate.

Two-component polyurethane coatings of the invention are particularly useful, for example, as high gloss coating materials, abrasion resistant materials, for example, for cement coatings.

Two-component water-based hydrophilic coatings of the invention may be used on a variety of substrates, for example, cement, plastic, paper, wood, metal, or any substrate where abrasion resistance is desired.

In one embodiment, the present invention is directed to an article comprising a substrate and a coating disposed on at least a portion of the substrate, wherein the coating comprises the cured reaction product of a reactive coating composition according to the present invention.

In order to further illustrate the invention and the advantages thereof, the following non-limiting examples are given.

### Comparative Examples C1, C2 and C3

The coating formulations of Comparative Examples C1, C2, and C3 were made by mixing several commercially available water emulsifiable polyisocyanate oligomer/surfactant blends (Rhodocoat™ X EZ-D 401 (100 percent by weight (“wt %”) solids), X EZ-M 501 (100 wt % solids), X EZ-M 502 (85 wt % solids) hydrophilic polyisocyanates, Rhodia Inc.) with an acrylic polyol (a water dispersible hydroxyl functional acrylic/styrene copolymer emulsion (46.5 wt % solids) available as Neocryl™ XK-110 polyol, DSM Neoresins) with and the other ingredients listed in Table 1 below in the relative amounts listed in Table 1 below. The weight percent of the solids in all three formulations were kept at 44.7%, as well as the NCO/OH ratio at 2.0.

TABLE 1

| Ingredients | Ex C1 (wt %) | EX C2 (wt %) | EX C3 (wt %) |
|---|---|---|---|
| Neocryl XK 110 | 57.68 | 60.60 | 56.79 |
| Eastman EEP | 2.62 | 1.99 | 1.80 |
| Water | 18.15 | 16.55 | 18.57 |
| Surfynol 104BC | 0.16 | 0.17 | 0.16 |
| BYK 340 | 0.41 | 0.43 | 0.40 |
| PolyFox PF-156A | 0.15 | 0.16 | 0.15 |
| Rhodocoat X EZ-D | 20.84 | 0 | 0 |
| 401 | | | |
| Rhodocoat X EZ-M | 0 | 16.36 | 0 |
| 501 | | | |
| Rhodocoat X EZ-M | 0 | 0 | 18.51 |
| 502 | | | |
| n-Butyl Acetate | 0 | 3.76 | |
| Eastman EEP | 0 | 0 | 3.98 |

The coating formulations were applied onto iron-phosphated steel test panels purchased from Q-Panel Lab Products. Coating application was made using a draw-down bar at a wet film thickness of 8 mils. The coated panels were cured in the controlled temperature (25° C.) and the controlled humidity (50% RAH.) (CATCH) room.

The films were tested for Person Hardness (ASTM D 4366) one day and seven days after the films cured, with the values reported in seconds.

Methyl ethyl ketene (MEK) double rub test is used to assess the development of cure. The test was done one day and seven days after the films cured. A 26 oz hammer with five layers of cheesecloth wrapped around the hammerhead was soaked in MEK. After 50 double rubs the hammer was rewet with MEK. Once mar was achieved the number of double rubs was noted. A fully cured coating was based on 300 double rubs without mar.

The abrasion resistance test (ASTM D 4060-95) was run on a uniform coating between 2 to 3 mils after seven-day cure. The result was reported as loss in weight (mg) under the test condition of 1000 cycles and 1 Kg weight using CS-17 wheels.

The gel fraction of the films after one-day cure was determined by Sox let extraction method. Approximately 0.5 g of the test film was placed in an extraction thimble and the extraction was conducted for 6 hours using 200 ml refluxing acetone. After removing the acetone and drying the residue and the thimble at 80° C. for one hour, the percentage of the gel fraction of the film was calculated based solely on the resin applied in the formulation.

Other testing methods, including tape adhesion and pencil hardness on steel panels, follow the ASTM test methods ASTM D 3359 and ASTM D 3363, respectively.

The film properties including gloss, adhesion, pencil hardness, Person hardness, MEK double rub test, pot life, dry time and abrasion resistance of films made form the compositions of Examples C1, C2, and C3 are summarized below in Table 2. The dry film build of the films were around 2.8 mils. Due to the hydrophilic of the three products, the compositions of Examples C1 and C3 result in high gloss films, while the composition of Example C2 results in a low gloss film. The one-day results of Person hardness and MEK double rub test show that all three formulations give films with excellent initial hardness and good crosslinking. The hardness of the films is in the sequence of C1>C2>X C3, while the MEK double rub test shows that C3>C1>C2.

TABLE 2

| Film Property | EX C3 | EX C2 | EX C1 |
|---|---|---|---|
| Gloss (20°/60°) | 85/94 | 38/73 | 81/83 |
| Adhesion | 5B | 5B | 5B |
| Pencil Hardness (7 days) | HB | H | H |
| Persoz Hardness (1/7 days) | 188/260 | 233/301 | 254/297 |
| MEK Double Rub Test (1/7 days) | 178/270 | 122/227 | 130/170 |
| Pot Life | >5 hours | >6 hours | >6 hours |
| Tack Free | 1.3 hours | 1.3 hours | 0.9 hours |
| Dry-Hard | 5.0 hours | 4.6 hours | 2.3 hours |
| Abrasion Resistance | 49 mg | 52 mg | 59 mg |
| (CS-17, 1 kg/1000 cycles) | | | |

It was found that the compositions of Examples C1, C2, and C3 resulted in hard films but relatively poor abrasion resistance as the general requirements for concrete coatings is less than 35 mg.

The pot life of the compositions of Examples C1, C2, and C3 was measured by both viscosity and gloss measurements. Coating viscosity is monitored using Zhan #2 cup method (ASTM D 4212) and the efflux time in seconds is recorded every one hour. The secular gloss was measured with a BY-Gardner gloss meter (ASTM D 523) after drawn down on a Lenexa chart at one hour intervals. The pot life is determined either by viscosity change and gelatin or by the gloss reduction, whichever comes first. The pot life of waterborne polyurethane coatings is different from solvent borne coatings. It is determined by both the viscosity profile after mixing the polyisocyanate with the polyol and the change of gloss as evolution of time. The pot life of the composition of Example C3, as Zhan cup (#2) viscosity, in seconds (“sec”) and gloss at 200 and 600, over time, is show in Table 3 below.

TABLE 3

| Time (hrs) | Zahn #2 (sec) | Gloss 20° | Gloss 60° |
|---|---|---|---|
| 0 | 29.93 | 84.8 | 93.7 |
| 1 | 25.84 | 83.8 | 94.2 |
| 2 | 22.88 | 82.7 | 94.1 |
| 3 | 22.92 | 79.7 | 94.4 |
| 4 | 24.88 | 80.2 | 93.9 |
| 5 | 24.06 | 79.4 | 94.0 |
| 6 | 23.13 | 71.8 | 93.1 |

The pot life results show that the viscosity decreased and fluctuated in the 6-hour testing period without the observation of gelatin. On the other hand, the 600 gloss maintained above 90 for at least 6 hours. The 200 gloss showed some decrease but kept above 80 for about 5 hours. Therefore, the pot life for the formulation of Example C3 is at least 5 hours. Similarly, the pot life of each of formulations C1 and C2 was also found to be at least 6 hours.

The dry time was studied by using BK dry time recorder (ASTM D 5895-96). The coating is applied at a wet film thickness of 150 am to one glass strip approximately 12 in by 1 in. The test method describes the determination of several stages and the rate of dry film formation. Usually four stages have been observed in organic film formation that include Set-to-Touch, Tack-Free, Dry-Hard, Dry-Through time. The dry time results for the formulations of Example C1, C2, and C3 are provided below in Table 4. As expected, the composition of Example C1 demonstrates the fastest dry time due to the presence of IPDT The Dry-Hard stage is reached at 2.3 hours and the Tack-Free time is 0.9 hours. In contrast, for compositions of Example C2 and C3, the Tack-Free time is 1.3 hours for both films; the Dry-Hard time is 4.6 hours and 5.0 hours, respectively.

TABLE 4

| BK Dry Time (hours) | EX C3 | EX C2 | EX C1 |
|---|---|---|---|
| Tack Free | 1.3 | 1.3 | 0.9 |
| Dry Hard | 5.0 | 4.6 | 2.3 |

Chemical resistance is another important aspect of film performance which is related to the crosslinking of the film. Resistance to each chemical was performed by spot test, covered under ambient conditions for 24 hours (ASTM D 1308). Ratings are based on a scale of 1 to 5 with 5 indicating no effect and 1 indicating total failure. The one-day and seven-day chemical resistance based on a 24-hour spot test for the compositions of Examples C1, C2 and C3 are shown below in Table 5 (a) and (b). After seven day cure at ambient conditions, all three films show excellent chemical resistance.

TABLE 5(a)
One-day Chemical Resistance

| Chemical | Ex C2 | Ex C3 | EX C1 |
|---|---|---|---|
| 10% H₂SO₄ | 5.0 | 5.0 | 5.0 |
| 10% Acetic Acid | 5.0 | 3.0 | 3.0 |
| MEK | 4.5 | 4.5 | 4.0 |
| Xylene | 3.5 | 4.0 | 4.5 |
| NH₃—H₂O | 5.0 | 5.0 | 5.0 |
| Skydrol | 3.0 | 4.0 | 3.0 |
| Mustard | 4.0 | 3.5 | 4.0 |
| Iodine | 3.0 | 3.0 | 3.0 |
| Methylene blue | 4.0 | 3.5 | 4.5 |
| Coffee | 5.0 | 5.0 | 5.0 |
| Water | 5.0 | 5.0 | 5.0 |

TABLE 5(b)
7-day Chemical Resistance

| Chemical | Ex C2 | Ex C3 | Ex C1 |
|---|---|---|---|
| 10% H₂SO₄ | 5.0 | 5.0 | 5.0 |
| 10% Acetic Acid | 5.0 | 5.0 | 5.0 |
| MEK | 4.5 | 4.5 | 4.5 |
| Xylene | 4.0 | 4.5 | 4.5 |
| NH₄—OH | 5.0 | 5.0 | 5.0 |
| Skydrol | 3.5 | 4.5 | 4.0 |
| Mustard | 4.5 | 4.5 | 4.5 |
| Iodine | 3.5 | 3.5 | 3.5 |
| Methylene blue | 5.0 | 5.0 | 5.0 |
| Coffee | 5.0 | 5.0 | 5.0 |
| Water | 5.0 | 5.0 | 5.0 |

### Examples 1 and 2 and Comparative Example C4

The coating formulations of Comparative Examples C1, C2, and C3 were made by mixing a commercially available water emulsifiable polyisocyanate oligomer/surfactant blend (Rhodocoat™ X EZ-M 502 hydrophilic polyisocyanate, Rhodia Inc.)) with an acrylic polyol (a water dispersible hydroxyl functional acrylic/styrene copolymer emulsion (46.5 wt % solids) available as NeocryI™ XK-110 polyol, DSM Neoresins), a flexible polyester polyol (Adurao 100 polyester polyol (Air Products and Chemicals Inc.) and the other ingredients listed in Table 6 below in the relative amounts listed in Table 6 below.

TABLE 6

| Ingredients | EX 1 (wt %) | Ex 2 (wt %) | EX C4 (wt %) |
|---|---|---|---|
| Neocryl XK 110 acrylic | 51.30 | 46.42 | 56.76 |
| polyol | | | |
| Adura ® 100 polyester | 1.80 | 3.43 | 0 |
| polyol | | | |
| Eastman EEP | 1.77 | 1.69 | 1.86 |
| Water | 21.48 | 23.64 | 18.56 |
| Surfynol 104BC | 0.15 | 0.14 | 0.16 |
| BYK 340 | 0.38 | 0.36 | 0.40 |
| PolyFox PF-156A | 0.14 | 0.14 | 0.15 |
| Rhodocoat X EZ-M | 19.43 | 20.57 | 18.14 |
| 502 isocyanate | | | |
| Eastman EEP | 3.54 | 3.62 | 3.98 |

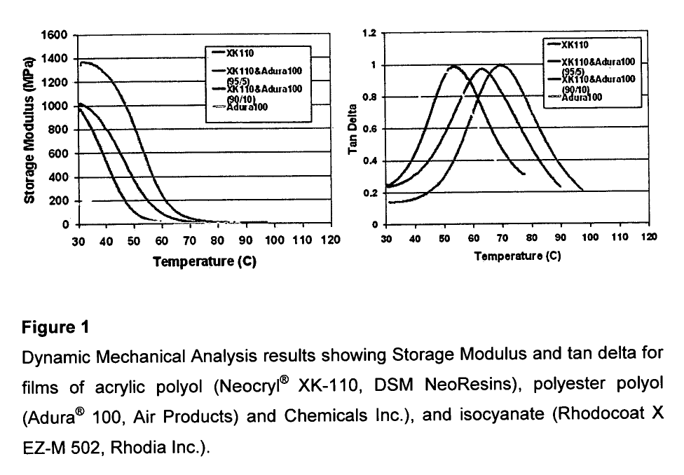

Films made by curing the compositions of Examples 1 and 2 were subjected to dynamic mechanical analysis. Dynamic mechanical analysis was performed on a TA Instruments DMA Q-800. The film samples were analyzed in tension at 1.0 Hz and 0.2% strain over a temperature range of −80° C. and 150° C. at a ramp rate of 3° C./min. As shown in FIG. 1, the one day storage modulus at room temperature was reduced with the addition of 5% and 10% polyester polyol. and Tg decreases as the weight fraction of polyester polyol increases. The single tan δ peak of the cured film further indicates that the acrylic polyol and the polyester polyol are compatible in the crosslinked film morphology.

As the weight fraction of the polyester polyol flexible chain increases, the abrasion resistance of blend films is found to improve to 42.5 mg and 32 mg for 5% and 10% wt polyester polyol, respectively.

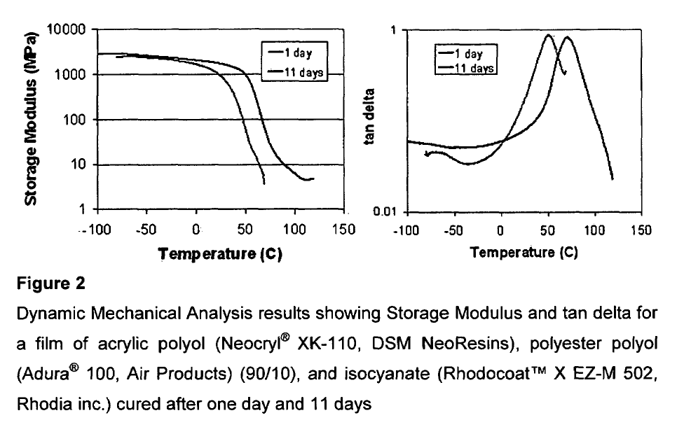

Shown in FIG. 2, only one Tg peak is found indicating the polyester polyol chains are compatible and well confined in the network morphology. A secondary transition around −50° C. indicates the local chain segment motion of the polyester polyol chains. DMA provides strong evidence of the interpenetrating network with the broadening of tan δ peak in the later stage of the curing process. The broadening of the tan δ peak suggests more phase mixing due to the IPN structure. The physical interlocking of the IPN structure prohibits phase separation when the molecular weight increases during the late stage curing process. The resulting IPN structure results in a lower hardness film but gives a toughening mechanism and improves the abrasion resistance of the coating.

### Examples 3 and 4

The compositions of Examples 3 and 4 were made by blending an acrylic polyol with a commercially available water emulsifiable polyisocyanate oligomer/surfactant blend (Rhodocoat™ X EZ-M 502 hydrophilic polyisocyanate, Rhodia Inc.)) with an acrylic polyol (a water dispersible hydroxyl functional acrylic/styrene copolymer emulsion (46.5 wt % solids) available as NeocryI™ XK-110 polyol, DSM Neoresins), and water dispersible polyester polyol (W2K2000 polyol (100 wt % solids), US Polymers, Inc.) in the relative amounts set forth below in Table 7.

TABLE 7

| Ingredients | EX 3 (wt %) | Ex 4 (wt %) |
|---|---|---|
| Neocryl XK-110 acrylic | 45.10 | 52.84 |
| polyol | | |
| W2K2000 polyester | 6.26 | 1.29 |
| polyol | | |
| Eastman EEP | 2.60 | 1.82 |
| water | 24.96 | 20.77 |
| Surfynol 104BC | 0.16 | 0.15 |
| BYK 340 | 0.41 | 0.39 |
| PolyFox PF-156A | 0.15 | 0.15 |
| Rhodocoat X EZ-M | 17.30 | 18.68 |
| 502 isocyanate | | |
| Eastman EEP | 3.06 | 3.90 |

The results of gloss, hardness, MEK double rub, pot life, tack free time, dry-hard time, and abrasion resistance are given below in Table 8. As shown in Table 8 both films have high gloss, excellent abrasion resistance and are very well crosslinked. The film hardness increases as the NCO/OH ratio increases. The increase in the weight fraction of polyester polyol W2K2002 does not significantly increase the dry time.

TABLE 8

| Film Properties | Ex 3 | Ex 4 |
|---|---|---|
| Gloss (20°/60°) | 87/93 | 89/93 |
| Persoz Hardness (1/7 days) | 67/192 | 125/292 |
| MEK Double Rub Test (1/7 days) | >200/>200 | >200/>200 |
| Pot Life | >5 hours | >5 hours |
| Tack Free | 2.1 hours | 1.4 hours |
| Dry-Hard | 5.8 hours | 5.2 hours |
| Abrasion Resistance | 28 mg | 32 mg |
| (CS-17, 1 kg/1000 cycles) | | |

1. A reactive coating composition, comprising:
(a) a water dispersible isocyanate component, comprising
(a)(1) one or more hydrophobic polyisocyanate oligomers,
(a)(2) one or more surface active agents, and
(b) a water dispersible polyol component, comprising:
(b)(1) one or more acrylic polyols, and
(b)(2) one or more polyester polyols.

2. The composition of claim 1, wherein the water dispersible isocyanate component (a) comprises:
(a)(1) from greater than 0 to less than 100 wt % of the one or more hydrophobic isocyanate oligomers, and
(a)(2) from greater than 0 to about 20 wt % of the one or more surface active agents.

3. The composition of claim 1, wherein the one or more hydrophobic isocyanate oligomers comprise one or more polyisocyanate oligomers derived from polycondensation of one or more diisocyanate or triisocyanate monomers.

4. The composition of claim 3, wherein the one or more isocyanate monomers comprise monomers selected from 1,6-hexamethylene diisocyanate, 4,4′ bis-(isocyanato cyclohexyl) methane, bis(isocyanato-methylcyclohexane) cyclobutane-1,3-diisocyante, cyclohexane-1,3-diisocyanate, cyclohexane-1,4-diisocyanate; norbornane diisocyanate; isophorone diisocyanate, 3-isocyanatomethyl-3,5,5-trimethylcyclo-hexylisocyanate,-2,4- or 2,6-toluene diisocyanate; 2,6-4,4′-diphenylmethane diisocyanate; 1,5-naphthalene diisocyanate, p-phenylene diisocyanate, and mixtures thereof.

5. The composition of claim 4, wherein the one or more isocyanate monomers comprise 1,6-hexamethylene diisocyanate, isophorone diisocyanate, or a mixture thereof.

6. The composition of claim 1, wherein the polyisocyanate oligomers have a combined average NCO functionality greater than 2.

7. The composition of claim 1, wherein the one or more surface active agents comprise one or more surfactant compounds that comprise, per molecule of surfactant compound, an anionic functional group, a polyalkylene oxide chain fragment, or an anionic functional group and a polyalkylene oxide chain fragment.

8. The composition of claim 1, wherein the one or more surface active agents comprise one or more surfactant compounds according to formula (I): 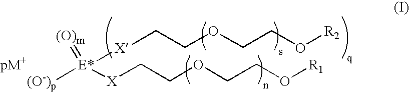
wherein:
q is 0 or 1;
p is 1 or 2;
m is 0 or 1;
the sum: 1+p+2m+q is equal to three or to five;
X and X′ are each independently divalent groups;
s is an integer from 1 to 30;
n is an integer from 1 to 30;
E is a carbon, phosphorus, or sulfur atom; and
R₁ and R₂ are each independently hydrocarbon radicals.

9. The composition of claim 1, wherein E is a phosphorus atom; and R₁ and R₂ are each independently alkyl.

10. The composition of claim 1, wherein the one or more surface active agents comprise one or more polyisocyanate oligomers that comprise, per molecule of oligomer, an anionic functional group, a polyalkylene oxide chain fragment, or an anionic functional group and a polyalkylene oxide chain fragment.

11. The composition of claim 1 wherein the acrylic polyol has a glass transition temperature of from 15 to about 100° C.

12. The composition of claim 2 wherein the acrylic polyol has a glass transition temperature of from about 20° C. to about 80° C.

13. The composition of claim 1 wherein the polyester polyol has a glass transition temperature of from about −100° C. to less than 15° C.

14. The composition of claim 4 wherein said polyester polyol has a glass transition temperature of from about −50° C. to less than 10° C.

15. The coating composition of claim 1, further comprising a solvent

16. A film, comprising the cured reaction product of the composition of claim 1.

17. The film of claim 16, wherein the film exhibits high resistance to abrasion, as indicated by a weight loss of less than or equal to about 40 milligrams from the film after a seven-day cure, as measured according to ASTM D 4060-95 under test conditions of 1000 cycles and 1 Kilogram weight using CS-17 wheels.

18. A coated substrate, comprising a substrate and a film supported on at least a portion of the substrate and comprising the cured reaction product of the composition of claim 1.

19. A method for coating a substrate, comprising applying a composition according to claim 1 to the substrate and allowing the coating to cure.
